(19) United States
(12) Patent Application Publication
(10) Pub. No.: US 2011/0016161 A1
(43) Pub. Date: Jan. 20, 2011

(54) SYSTEM AND METHOD FOR THE SELECTION OF CONTEXT SENSITIVE USER PROFILE FRAGMENTS

(75) Inventor: Shoshana Loeb, Philadelphia, PA (US)

Correspondence Address: TELCORDIA TECHNOLOGIES, INC., ONE TELCORDIA DRIVE 5G116, PISCATAWAY, NJ, 08854-4157, US

(73) Assignee: TELCORDIA TECHNOLOGIES, INC., Piscataway, NJ (US)

(21) Appl. No.: 12/645,955

(22) Filed: Dec. 23, 2009

Related U.S. Application Data
(60) Provisional application No. 61/226,915, filed on Jul. 20, 2009.

(51) Int. Cl. G06F 3/01; G06F 17/30

(52) U.S. Cl. 707/805; 715/745; 707/E17.005

(57) ABSTRACT

A method and system for collecting and generating context sensitive data for consumer profiles and presenting a contemporaneous context sensitive model of consumer preferences to a user. An interpreter module obtains event data of a user's activity and obtains personal user data. The interpreter module associates the event data with context information using predetermined context parameters and selects profile fragments corresponding to the context information. An assembly module generates a composite profile from the profile fragments, and a personalization module prepares a model of the user's composite profile which can be displayed.

### CROSS-REFERENCE TO RELATED APPLICATIONS

This application claims priority under 35 U.S.C. §119(e) of U.S. Provisional Patent Application Ser. No. 61/226,915, filed Jul. 20, 2009, the disclosure of which is hereby incorporated by reference in its entirety. Additionally, this application is related to the following commonly-owned, co-pending U.S. patent application Ser. No. 12/627,360, filed on Nov. 30, 2009, the contents and disclosure of which is expressly incorporated by reference herein in its entirety.

### FIELD OF THE INVENTION

The present invention relates generally to a system and method for selecting context sensitive information about a person's preferences in particular contexts.

### BACKGROUND OF THE INVENTION

Systems and methods provide for collecting accurate data of context-sensitive information and/or data about consumer preferences. Exemplary systems obtain data regarding interests and usage behavior, for example, using data collection methods such as using focus groups, questionnaires, and other techniques for collecting raw data. The accurate capture of a user profile is used to deploy effective and efficient information filtering and personalized systems for providing custom information, advertising, products and/or systems to a user. The accurate capture of user profile is key to the deployment of effective and efficient information filtering and personalization systems. The user profile can be acquired in two ways: either the user specifies it explicitly, or the system infers it from the user behavior. For example, data describing or categorizing the books a person buys can be used to present possible additional book choices to a user.

One problem with current selection techniques is that a user may have more than one profile, and that any given profile or profile fragment is only valid in a particular context and/or at a particular time. Thus, any one or all of the profiles is not relevant in real time, and/or not subject relevant. Another disadvantage of a data selection and presentation system as described above is that information presented to a user may be entirely based on an irrelevant profile, untimely profile, or include irrelevant information from a broad profile pool (e.g., demographic information).

Further, current profile selection methods do not consider a framework in which user profiles and/or sub-profiles are dynamic, e.g., time and context sensitive entities. As a result, current methods suffer from the drawback of not distinguishing aspects of the user profile that are context sensitive and bundling all of the them into a single profile with limited accuracy to predict future preferences.

There is therefore a need for a profile selection system and related method able to provide more discriminating profiles of users resulting in enhanced accuracy in presenting information to the user. Further, there is a need for data presented to a user to more particularly reflect user preferences and/or contemporaneous usage.

### SUMMARY OF THE INVENTION

In a aspect of the invention, a method for selecting context sensitive user profiles and presenting a model of consumer preferences includes providing a data storage device included in a computer system, the computer system including a program stored in the data storage device, steps of the program, which are executed by a processer, include obtaining event data of a user's activity from a data interface, associating the event data with context information using predetermined context parameters, selecting profile fragments corresponding to the context information from a plurality of profile fragments, generating at least one composite profile from the selected profile fragments, and displaying selected contents of the at least one composite profile.

In a related aspect of the invention, the method further comprises interpreting the event data and correlating the context information with the plurality of profile fragments. In one embodiment, the method further comprises creating a composite profile model. In one embodiment, the method further comprises collecting additional new event data from the data interface, and interpreting and correlating the additional new event data with the data in the sub-profiles using the predetermined context parameters. The context parameters can include timeline data of the user's activity provided by the data interface, and personal user data, and/or timeline data of the user's activity, the user's location provided by the data interface, and personal user data, wherein the event data and the timeline data occur during the same period of time. In one embodiment, the personal user data is provided by the user using the data interface. The data interface can offer services from a service provider selectable by the user, and can comprise collecting timeline data from the service provider during the user's activity. In a further related aspect, the method steps are automatically initiated by the computer program.

A program storage device readable by a machine, tangibly embodying a program of instructions executable by the machine to perform methods described herein may be also provided.

In another aspect of the invention, a system for selecting and generating data in consumer profiles and presenting a model of consumer preferences including a computer system including a program stored in a data storage device and steps of the program being executed by a processer. The system further includes a data interface for use by a user and an interpreter module obtaining event data of a user's activity and obtaining personal user data. The interpreter module associates the event data with context information using predetermined context parameters, and selects sub-profiles or profile fragments corresponding to the context information from a plurality of profile fragments. A data storage device communicates with the computer system and stores the event data and new event data of the user's activity. An assembly module generates at least one composite profile from the sub-profiles or profile fragments, and a personalization module prepares at least one model of the user's composite profile. A display presents the at least one model of the user's composite profile.

In a related aspect, the interpreter module further collects additional new event data from the data interface. The interpreter module interprets and correlates the additional new event data with the data in the sub-profiles using the predetermined context parameters. The interpreter module selects at least one of the sub-profiles corresponding to the additional new event data to provide at least one new context sensitive sub-profile. The assembly module generates at least one updated composite profile from the at least one new context sensitive sub-profile wherein the at least one new context sensitive sub-profile provides context sensitive data in relation to the additional new event data.

In a related aspect, the data interface offers services from a service provider which are selectable by the user. The interpreter module may generate a multiplicity of initial profiles and sub-profiles for each of a plurality of users, and wherein each initial profile and sub-profile includes categories of information about the corresponding user. The data interface may be a mobile device.

### BRIEF DESCRIPTION OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 is a schematic block diagram of a system and method for selecting context sensitive consumer information according to an embodiment of the invention;

FIG. 2 is a schematic block diagram of the embodiment of the invention shown in FIG. 1 further depicting components of the invention; and

FIG. 3 is a flow chart illustrating a method according to an embodiment of the invention for selecting context sensitive consumer information.

### DETAILED DESCRIPTION OF THE INVENTION

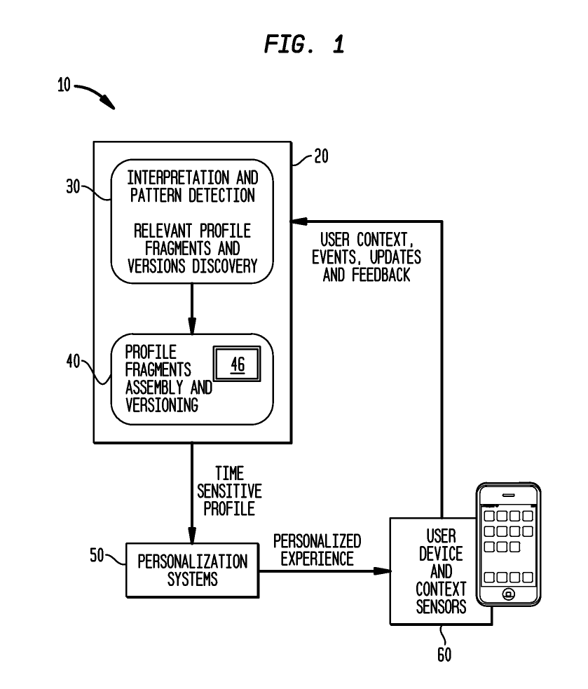

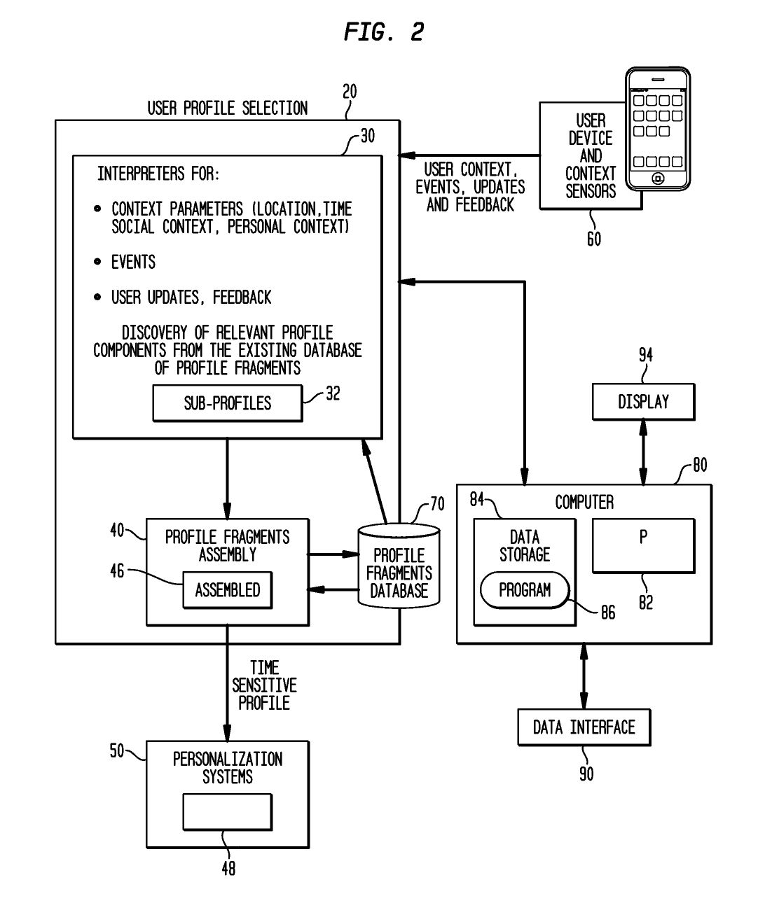

Referring to FIGS. 1 and 2, a system 10 and related method for selecting context sensitive data includes a computer system 80. The computer system 80 includes a data storage device 84 for storing a program 86 and a processor 82 for executing the steps of the program 86. The computer system 80 communicates with a profile selection module 20. The profile selection module 20 includes an interpreter and patterning detection component 30 (referred to herein as the interpreter component or interpreter module), and a composite profile assembly component 40 (referred to herein as the assembly component or assembly module).

Referring to FIGS. 1 and 2, user events are captured by the system 10 via a data interface or a context sensitive sensor embodied in the present embodiment of the invention as the personal data assistant (FDA) 60. The PDA 60 provides user location, time and task information, as well as social context and explicit user input. The event data from the PDA 60 is received by the interpreter component 30. The interpreter component 30 determines the context of the event data obtained from the PDA 60. The interpreter component 30 accesses one or more profile fragments or sub-profiles 32 that correspond to the received data. These sub-profiles 32 may be stored in the database 70. The interpreter component 30 interprets the context of the event data and selects the event data corresponding to context sensitive data using context parameters. The context parameters may include, for example, timeline data of the user's activity, the user's location, the user's calendar information, the user's to-do list, and other personal user data. The personal user data may be provided by the user using, for example, the user's data interface, such as the FDA 60, or a mobile device or computer.

In one embodiment, referring to FIG. 2, the interpreter component 30 of the system 10 additionally includes, for example, interpreter context parameters such as location and time, social context and personal context, events, and user updates or feedback. The interpreter component 30 communicates with the database 70 and communicates with the assembly component 40.

The assembly component 40 receives the sub-profiles 32 from the interpreter component 30 and generates or assembles the composite profiles 46. These may be stored in the database 70. The database 70 can index the sub-profiles 32 using the context parameters.

The sub-profiles 32 can be accessed by the interpreter component 30 in response to new event data collected from the PDA 60. The interpreter component 30 then selects one or more context sensitive or context relevant sub-profiles 32 for assembly by the assembly component 40 which creates an updated or new composite profile 48. For example, the PDA 60 may generate data such as changes in location, time changes as well as input changes by the user. The interpreter component 30 automatically collects the new event data. More specifically, additional or new time sensitive event data obtained by the interpreter component 30 from the PDA 60 is correlated with the data in the sub-profiles 32 using the context parameters. The steps described above for generating or assembling the composite profile model 48 can be automatically initiated by the system 10.

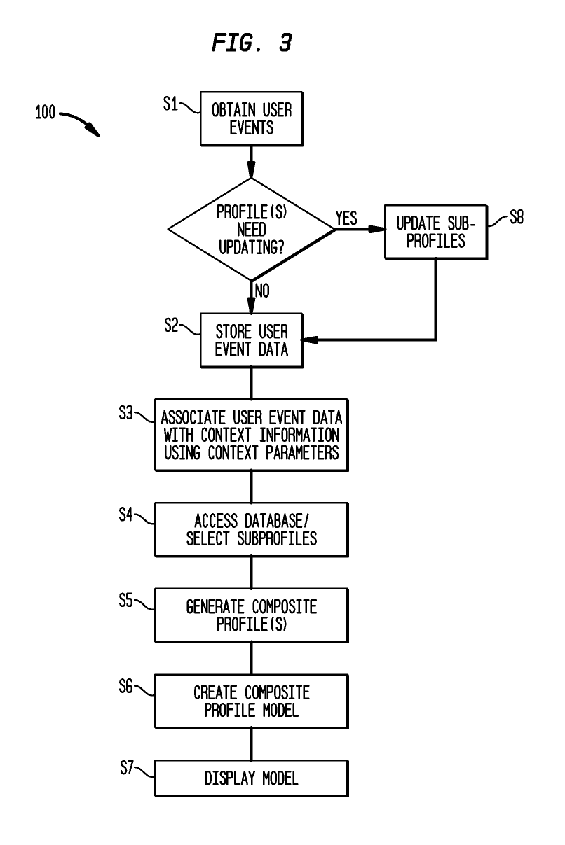

The software program 86 generates the interpreter component 30 and assembly component 40 for generating the composite profile 46. The software program 86 uses the composite profile 46 to generate one or more models 48 of a user's behavior relating to the context of the user's usage. The models 48 can be used to profile categories of users. The software program 86 uses the composite profile 46 to present the model 48 on a display 94 to a user, shown in FIG. 2, and referred to in step S7 of FIG. 3.

In an embodiment of the invention, user information/data may be inputted into a data interface 90 by a user. The data interface may be embodied as a personal data assistant (PDA) 60 providing, for example, the user's location, calendar information, to-do list, entertainment data, and other personal user data. Other embodiments of data interfaces or context sensitive sensors may include, for example, a computer, a mobile phone, or other interactive devices, collectively embodied as the data interface 90. The user's selections in purchasing items or selecting entertainment may include events, for example, wherein a user selects a program from a viewing menu, browsing and/or selecting information or entertainment, and starting and stopping searches, viewing, downloading, and/or modifying the selections. Data reflecting a user's selections can be sent to a data storage device embodied as a database 70.

The interpreter component 30 creates profile fragments or sub-profiles 32 from the context sensitive data which are assembled into a single user composite profile 46 by the assembly component 40. The assembly component 40 applies pre-defined policies to manage possible conflicts in the sub-profiles 32, and to prioritize preferences. The composite profile 46 is received by a personalization module 50 which creates a composite profile model 48 for presentation to a user based on the composite profile 46.

FIG. 3 is a flow diagram of a method 100 according to an embodiment of the invention shown in FIGS. 1 and 2. In step S1, user events can be collected from the PDA 60. The user events may be initiated by a user selecting preferences on the data interface 90 or the PDA 60, as well as location and time data provided by the PDA 60. In step S2, the usage and/or event data is sent to the database 70. In step S3, the interpreter component 30 of the profile selection module 20 associates the context parameters with a current user event data. In step S4, the database 70 is accessed to retrieve context specific data, i.e., one or more context relevant profile fragments or sub-profiles 32. In step S5, the assembly component 40 searches and generates composite profiles 46 from the sub-profiles 32 retrieved from the database 70 in accordance with the user event data. In step S6, the composite profiles 46 are used to create a composite profile model 48. The composite profile model 48 is presented to the user in step S7, for example, on a computer monitor or PDA 60. The context sensitive user composite profile 46 can be used by an information filtering or personalization system 50. The model 48 thus provides the user with contemporaneous context sensitive information, for example, selections, data, files, or links to pertinent information, e.g., on a computer network or the Internet.

In the inventive method 100, the data for a sub-profile 32 can be updated in step S8. Such updating occurs based on the rules or pre-defined profile update policies.

Thus, the system 10 and method 100 of the present invention provide a composite profile at a given time, i.e., contemporaneously with the event data, and thus provides context sensitive profiles (for example, time-sensitive), as a dynamic composite of profile fragments or sub-profiles assembled based on events, feedback, context information and explicit user updates.

In another embodiment, the interpreter component 30 can create context relevant sub-profiles 32 from initial profiles based on the context of the event data. Each sub-profile 32 can be modified and maintained independently. Each user sub-profile 32 which the system 10 stores in database 70 is indexed by time, location, task being performed, social context and other relevant parameters.

Thereby, the system 10 and method 100 of the present invention select context sensitive user data and create a composite profile of sub-profiles 32 which are context and time sensitive in relation to event data collected from a user's PDA 60. In addition, the system 10 and method 100 of the present invention provide a mechanism to select sub-profiles 32 relevant to a particular context/situation using the interpreter component 30, and to assemble the sub-profiles 32 using the assembly component 40 into a context sensitive user composite profile 46 for use by an information filtering or personalization system 50.

In an exemplary embodiment of the invention, for example, a user is driving alone to work in his or her car. The appropriate sub-profiles for this situation can be work related information, driving music, general world news, etc. Each of the sub-profiles can also be used in a different combination in other situations. For example, the driving music sub-profile can be combined with relaxation music, or with an entertainment/comedy audio sub-profile when the same user is driving home or is driving to a vacation spot. Thus, the system 10 provides the flexibility to add various context dimensions to the composite profile, and hence offer an advanced methodology to characterize user's preferences. For example, the user may prefer a particular news station or song while driving to work, however, the user may not like the same settings while driving home from work or while on vacation. Creating and maintaining sub-profiles provides information filtering and personalization for accommodating user preference in different contexts and time periods, while preserving different preference for other contexts.

As will be appreciated by one skilled in the art, the present invention may be embodied as a system, method or computer program product. Furthermore, the present invention may take the form of a computer program product embodied in any tangible medium of expression having computer usable program code embodied in the medium. In the present invention, any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. In the context of this document, a computer-usable or computer-readable medium may be any medium that can contain, store, communicate, propagate, or transport the program for use by or in connection with the instruction execution system, apparatus, or device. The computer usable program code may be transmitted using any appropriate medium, including but not limited to wireless, wireline, optical fiber cable, RF, etc. Computer program code for carrying out operations of the present invention may be written in any combination of one or more programming languages, including for example, object oriented programming languages. Computers, for example, user's computer and servers, may communicate and be connected using any type of network, including a local area network (LAN) or a wide area network (WAN), or the connection may be made to an external computer (for example, through the Internet using an Internet Service Provider).

The present invention is described with reference to flowchart illustrations and/or block diagrams, or schematic diagrams of methods, apparatus (systems) and computer program products according to embodiments of the invention. It is understood that each block of the flowchart illustrations and/or block diagrams, and combinations of blocks in the flowchart illustrations and/or block diagrams, can be implemented by computer program instructions. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

While the present invention has been particularly shown and described with respect to preferred embodiments thereof, it will be understood by those skilled in the art that changes in forms and details may be made without departing from the spirit and scope of the present application. It is therefore intended that the present invention not be limited to the exact forms and details described and illustrated herein, but falls within the scope of the appended claims.

What is claimed is:

1. A method for selecting data in consumer profiles and presenting consumer preferences, comprising:
providing a data storage device included in a computer system, the computer system including a program stored in the data storage device, steps of the program being executed by a processer;
obtaining event data of a user's activity from a data interface;
associating the event data with context information using predetermined context parameters;
selecting profile fragments corresponding to the context information from a plurality of profile fragments;
generating at least one composite profile from the selected profile fragments; and
displaying selected contents of the at least one composite profile.

2. The method of claim 1, wherein the step of associating further comprises interpreting the event data and correlating the context information with the plurality of profile fragments.

3. The method of claim 1, further comprising:
creating a composite profile model.

4. The method of claim 1, further comprising:
collecting additional new event data from the data interface;
and interpreting and correlating the additional new event data with the sub-profiles using the predetermined context parameters.

5. The method of claim 1, wherein the steps are automatically initiated by the computer program.

6. The method of claim 1, wherein the context parameters include: timeline data of the user's activity provided by the data interface, and personal user data.

7. The method of claim 1, wherein the context parameters include: timeline data of the user's activity, the user's location provided by the data interface, and personal user data, wherein the event data and the timeline data occur during the same period of time.

8. The method of claim 7, wherein the personal user data is provided by the user using the data interface.

9. The method of claim 1, wherein the data interface offers services from a service provider selectable by the user, and further comprising:
collecting timeline data from the service provider during the user's activity.

10. A computer program product comprising a computer readable medium having recorded thereon a computer program, a computer system including a processor for executing the steps of the computer program for generating a model of consumer preferences, the computer program product using a data interface for collecting data about selections of the user, the program steps comprising:
providing a data storage device included in a computer system, the computer system including a program stored in the data storage device, steps of the program being executed by a processor;
obtaining event data of a user's activity from a data interface;
associating the event data with context information using predetermined context parameters;
selecting profile fragments corresponding to the context information from a plurality of profile fragments;
generating at least one composite profile from the selected profile fragments; and
displaying selected contents of the at least one composite profile.

11. The computer program product of claim 10, wherein the step of associating further comprises interpreting the event data and correlating the context information with the plurality of profile fragments.

12. The computer program product of claim 10, further comprising creating a composite profile model.

13. The computer program product of claim 10, wherein the steps are automatically initiated by the computer program.

14. The computer program product of claim 10, further comprising generating a new composite profile initiated by the user using the data interface.

15. The computer program product of claim 10, further comprising:
collecting additional new event data from the data interface; and
interpreting and correlating the additional new event data with the sub-profiles using the predetermined context parameters.

16. A system for collecting and generating data in consumer profiles and presenting a model of consumer preferences, comprising:
a computer system including a program stored in a data storage device and steps of the program being executed by a processer;
a data interface for use by a user;
an interpreter module obtaining event data of a user's activity and obtaining personal user data, the interpreter module associating the event data with context information using predetermined context parameters and selecting profile fragments corresponding to the context information from a plurality of profile fragments;
a data storage device communicating with the computer system and storing the event data and new event data of the user's activity;
an assembly module generating at least one composite profile from the selected profile fragments;
a personalization module preparing at least one model of the user's composite profile; and
a display presenting the at least one model of the user's composite profile.

17. The system of claim 16, wherein the data interface offers services from a service provider which are selectable by the user.

18. The system of claim 16, wherein the interpreter module generates a multiplicity of initial profiles and sub-profiles for each of a plurality of users, and wherein each initial profile and sub-profile includes categories of information about the corresponding user.

19. The system of claim 16, wherein the assembly module interprets the event data and correlates the context information with the plurality of profile fragments.

20. The system of claim 16, wherein the data interface is a mobile device.
